(19) United States
(12) Patent Application Publication
(10) Pub. No.: US 2026/0265594 A1
(43) Pub. Date: Sep. 10, 2026

(54) POLYAMIDOAMINE-EPIHALOHYDRIN YANKEE ADHESIVES WITH ENHANCED STABILITY

(71) Applicant: ECOLAB USA Inc., St. Paul, MN (US)

(72) Inventors: Jia-Yu WANG, Naperville, IL (US); Gary Samuel FURMAN, JR., St. Charles, IL (US); Megan WALL, Woodridge, IL (US); Mei LIU, Plainfield, IL (US); Tiandi ZHUANG, Bolingbrook, IL (US); Aide WU, Naperville, IL (US)

(73) Assignee: ECOLAB USA Inc., St. Paul, MN (US)

(21) Appl. No.: 19/552,284

(22) Filed: Feb. 27, 2026

Related U.S. Application Data
(60) Provisional application No. 63/767,822, filed on Mar. 6, 2025.

(51) Int. Cl. C09J 177/06; C08K 5/098; D21F 5/18; D21H 21/14

(52) U.S. Cl. CPC C09J 177/06; C08K 5/098; D21F 5/181; D21H 21/146

(57) ABSTRACT

Methods and compositions for improving a papermaking process are provided herein. The compositions include, for example, a PAE resin and an organic base. The compositions may optionally include an organic acid or other additive. The methods may include adding an effective amount of the composition to a surface, such as a heated surface. For example, the composition may be sprayed onto the surface. A Yankee dryer, for example, may include the surface.

### TECHNICAL FIELD

The present disclosure generally relates to methods of improving a papermaking process and especially to the manufacture of hygiene paper grades including paper towels, napkins, facial and bath tissues. More particularly, the disclosure provides compositions of reactive polyamidoamine-epihalohydrin (PAE) adhesives with an extended shelf-life and methods of using the compositions as Yankee adhesives in tissue and towel production.

### BACKGROUND

Tissue making involves the preparation of a paper product from an aqueous suspension of cellulosic fibers by forming a wet web of interwoven fibers and removal of water from the wet web by various dewatering methods, such as free drainage, vacuum, and pressing to form a sheet. The sheet is then transferred to a heated cylinder (e.g., Yankee dryer) to further reduce the moisture content by evaporative and convective (hot air impingement from hoods) drying. The sheet is then subjected to a creping process where it is scraped off the cylinder.

PAE is a water-soluble polymeric resin that is widely used either as a permanent wet strength resin (WSR) for paper and paperboard products or as a Yankee adhesive for assisting tissue and towel paper making. It is synthesized by reacting a polyamidoamine backbone with epihalohydrin, typically, epichlorohydrin. The reaction leads to a quaternary ammonium salt in the backbone of the polymer network, as shown in the following scheme.

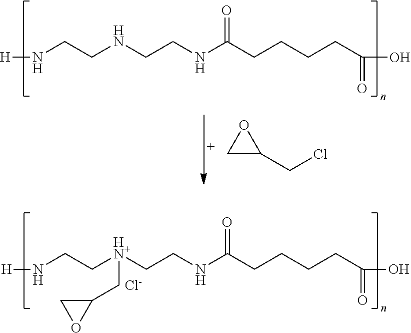

Depending on the desired end-product characteristics, the synthesis may require an excess of epichlorohydrin to ensure all secondary or primary amines are converted to quaternary ammonium salts.

At a pH of about 3, tertiary amines are protonated. The linear chlorohydrin conversion to the azetidinium cyclic structure is developed in parallel with the further crosslinking reaction. The number of linear units and the number of cyclic units depends on the epichlorohydrin concentration and reaction time. Thus, there are four possible structures for the ionic units as shown in the following scheme.

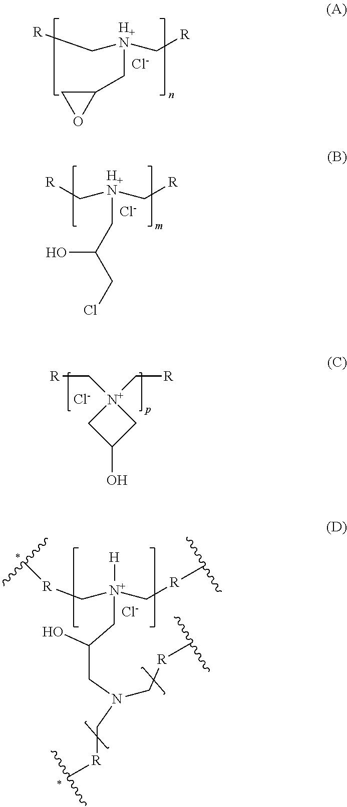

PAE resins are highly reactive. The halogenated alkyl amine (structure B) can be converted to the cyclic quaternary ammonium salt (structure C) or to a cross-linked macromolecule (structure D) through an intermolecular reaction. The latter results in higher molecular weight species. The polyamidoamine backbone, on the other hand, undergoes a hydrolysis reaction to form lower molecular weight species. Because of this highly reactive nature, PAE resins, especially those with active cyclic quaternary ammonium salt (azetidinium groups) known as reactive or crosslinkable or thermosetting PAE, have poor storage stability. Although influenced by concentration, temperature, level of azetidinium groups and pH, the shelf-life of a crosslinkable PAE resin is in general approximately three months at ambient temperature. This short shelf-life causes unnecessary product waste due to expiration before consumption, inconsistent product quality over time and limits access for consumers who use small quantities or are in areas with limited distribution.

### BRIEF SUMMARY

The present disclosure provides methods and compositions for improving a papermaking process.

In some embodiments, a composition of the present disclosure comprises a polyamidoamine-epihalohydrin (PAE) resin and an organic base.

In some embodiments, a method of the present disclosure comprises adding an adhesive composition to a heated surface to form a treated surface, adhering a paper sheet to the treated surface, and removing the paper sheet from the treated surface, wherein the adhesive composition comprises a PAE resin and an organic base.

In certain embodiments, the present disclosure provides a method of preparing an adhesive composition comprising adding a PAE resin to a solvent and adding an organic base to the solvent.

The foregoing has outlined rather broadly the features and technical advantages of the present disclosure in order that the detailed description that follows may be better understood. Additional features and advantages of the disclosure will be described hereinafter that form the subject of the claims of this application.

### DETAILED DESCRIPTION

Various embodiments are described below with reference to the drawings in which like elements generally are referred to by like numerals. The relationship and functioning of the various elements of the embodiments may better be understood by reference to the following detailed description. However, embodiments are not strictly limited to those illustrated in the drawings or described below.

Examples of methods and materials are described below, although methods and materials similar or equivalent to those described herein can be used in practice or testing of the present disclosure. All publications, patent applications, patents and other reference materials mentioned herein are incorporated by reference in their entirety. The materials, methods, and examples disclosed herein are illustrative only and not intended to be limiting.

Unless otherwise defined, all technical and scientific terms used herein have the same meaning as commonly understood by one of ordinary skill in the art. In case of conflict, the present document, including definitions, will control.

The term “pulp furnish” means a mixture comprising a liquid medium, such as water, within which solids, such as fibers (for example cellulose fibers) and optionally fillers, are dispersed or suspended such that between about >99% to about 45% by mass of the furnish is the liquid medium. The portion of the papermaking process prior to the press section (or prior to the through air dryers if working on a TAD machine) where a liquid medium, such as water, comprises more than about 45% of the mass of the substrate is referred to as the “wet end.” When working with a TAD machine, through air dryers will dry the sheet from approximately 20% consistency to about 65-90% consistency prior to the Yankee dryer. The term “dry end” refers to that portion of the papermaking process including subsequent to the press section (or through air dryers) where a liquid medium, such as water, typically comprises less than about 45% of the mass of the substrate.

The furnish, and thus a sheet formed from the furnish, may comprise, for example, a natural fiber, a synthetic fiber, a chemical pulp, a mechanical pulp, a vegetable fiber, a recycled fiber, a filler, or any combination thereof.

The present disclosure provides methods for extending the shelf-life of an adhesive, such as an aqueous thermosetting PAE resin, which may be used as an adhesive (e.g., Yankee adhesive) in the manufacture of paper, packaging, tissue, towel paper, etc. The disclosure also provides compositions having an extended shelf-life.

The compositions of the present disclosure comprise the PAE resin along with an organic base, which acts to capture excess free protons to slow or stop the hydrolysis reaction.

The organic base is not particularly limited and may be selected from, for example, an acetate, an acetylsalicylate, an adipate, an ascorbate, a benzoate, a citrate, a 2,4-dihydroxy benzoate, a fumarate, a formate, a glycolate, a gluconate, a glutarate, a 4-hydroxybenzoate, a lactate, a malate, an oxalate, a phthalate, a propionate, a pyruvate, a succinate, a tartrate, and any combination thereof. A complete list of organic bases with pKb value of 9 to 11 can be derived from the list of organic acids with pKa values of 3 to 5 listed in organicchemistrydata.org, the contents of which are incorporated by reference herein.

In some embodiments, the organic base comprises a pKb from about 9 to about 11, such as from about 9 to about 10, about 10 to about 11, about 9.5 to about 10.5 or about 9.8 to about 10.2.

The amount of organic base in the composition is not particularly limited. In some embodiments, the amount of organic base in the composition may range from about 0.1 wt. % to about 10 wt. %, such as about 0.1 wt. % to about 8 wt. %, about 0.1 wt. % to about 6 wt. %, about 0.1 wt. % to about 4 wt. %, about 0.1 wt. % to about 2 wt. %, about 0.1 wt. % to about 1 wt. %, about 0.1 wt. % to about 0.5 wt. %, about 0.5 wt. % to about 10 wt. %, about 1 wt. % to about 10 wt. %, about 3 wt. % to about 10 wt. %, about 5 wt. % to about 10 wt. %, or about 7 wt. % to about 10 wt. %.

The PAE resin is not particularly limited and may comprise, for example, a polyamidoamine-epichlorohydrin and/or a polyamidoamine-epibromohydrin.

The polyamides may be formed from the condensation polymerization of one or more organic dicarboxylic acid derivatives and one or more polyalkylene polyamines under conditions suitable for forming long-chain polyamides, such as at temperatures of about 130° C. or more for several hours (e.g., 2-5) with removal of water and/or alcohol byproducts.

Generally, a sufficient amount of organic dicarboxylic acid derivative to react with substantially all of the primary amino groups but insufficient to react to any significant degree with the secondary amino groups of the polyalkylene polyamine is used. In some embodiments, the organic dicarboxylic acid derivative and polyalkylene polyamine are reacted in a molar ratio of about 0.8:1 to about 1.4:1, such as about 0.9:1 to about 1.0:0.9.

Organic dicarboxylic acid derivatives include aliphatic and aromatic dicarboxylic acids and their corresponding acid chlorides, anhydrides and esters, and mixtures thereof. Esters may be C₁-C₃ aliphatic esters, for example. Representative organic dicarboxylic acids and their derivatives include maleic acid, succinic acid, glutaric acid, adipic acid, pimelic acid, suberic acid, azelaic acid, sebasic acid, phthalic acid, isophthalic acid, terephthalic acid, naphthalenedicarboxylic acid, dimethyl maleate, dimethyl malonate, diethyl malonate, dimethyl succinate, di-isopropyl succinate, dimethyl glutarate, diethyl glutarate, dimethyl adipate, methyl ethyl adipate, dimethyl sebacate, dimethyl phthalate, dimethyl isophthalate, dimethyl terephthalate, dimethyl naphthalenedicarboxylate, dibasic esters (DBE), poly(ethylene glycol) bis(carboxymethyl)ether, succinyl chloride, glutaryl dichloride, adipoyl chloride, sebacoyl chloride, sebacate, phthaloyl chloride, isophthaloyl chloride, terephthaloyl chloride, naphthalenedicarboxylate, maleic anhydride, succinic anhydride, glutaric anhydride, phthalic anhydride, 1,8-naphthalic anhydride, and the like.

A polyalkylene polyamine of the present disclosure includes, for example, an organic compound having two primary amine (—NH₂) groups and at least one secondary amine group where the amino nitrogen atoms are linked together by alkylene groups, provided no two nitrogen atoms are attached to the same carbon atoms. Representative polyalkylene polyamines include diethylenetriamine (DETA), triethylenetetraamine (TETA), tetraethylenepentaamine (TEPA), dipropylenetriamine, and the like.

The polyamidoamine is then reacted with epihalohydrin (e.g., epichlorohydrin) under controlled conditions to form the PAE resin. For example, the polyamidoamine may be diluted with water to a concentration of about 10 to about 50 weight percent, and the solution may be cooled to about 25° C. or less. An amount of epihalohydrin sufficient to react with the desired amount of the secondary amino groups in the polyamidoamine may then be slowly added in the solution. The mixture may then be heated at a temperature of about 40° C. to about 100° C. until the desired viscosity is reached, typically about 2 to about 8 hours. The preparation of suitable PAE resins is described in U.S. Pat. Nos. 6,277,242, 8,246,781, and 9,611,590 the contents of which are incorporated by reference into the present application in their entirety.

To produce a PAE resin, the amount of epihalohydrin introduced for reaction with the prepolymer is not particularly limited. In illustrative embodiments, the molar ratio of epihalohydrin to secondary amine groups in the prepolymer typically is kept below about 1.5:1, i.e., 1.5 molecules of epihalohydrin for each secondary amine group in the prepolymer. The molar ratio of epihalohydrin to the secondary amine groups in the polyamide prepolymer may be, for example, between about 0.05:1 and about 1.5:1, such as between about 0.05:1 and about 1.25:1, less than about 1.2:1, about 1.1:1, less than about 1:1, about 0.1:1 to 0.8:1, or about 0.2:1 to 0.7:1.

The PAE resin may comprise, for example, from about 1 mol % to about 20 mol % of an aminohalohydrin group, such as about 1 mol % to about 18 mol %, about 1 mol % to about 16 mol %, about 1 mol % to about 14 mol %, about 1 mol % to about 12 mol %, about 1 mol % to about 10 mol %, about 1 mol % to about 8 mol %, about 1 mol % to about 6 mol %, about 1 mol % to about 4 mol %, about 2 mol % to about 20 mol %, about 4 mol % to about 20 mol %, about 6 mol % to about 20 mol %, about 8 mol % to about 20 mol %, about 10 mol % to about 20 mol %, about 12 mol % to about 20 mol %, about 14 mol % to about 20 mol %, about 16 mol % to about 20 mol %, or about 18 mol % to about 20 mol %,

The weight average molecular weight of the PAE resin is not particularly limited. For example, the PAE resin may comprise a weight average molecular weight of about 50,000 Da or more, such as about 50,000 Da to about 1,500,000 Da, about 100,000 Da to about 1,500,000 Da, about 200,000 Da to about 1,500,000 Da, about 300,000 Da to about 1,500,000 Da, about 400,000 Da to about 1,500,000 Da, about 500,000 Da to about 1,500,000 Da. The PAE resin of the present disclosure is able to keep/hold its original molecular weight within 30% variation even after storage for 30 days or more at temperature higher than 35° C. and 180 days or more at ambient temperature, which, in accordance with the present disclosure, is a temperature of about 20° C. to about 25° C., such as about 21° C., about 22° C., about 23° C., or about 24° C.

The PAE resin of the present disclosure comprises a variable amount of an azetidinium group. For example, the PAE resin may comprise from about 1 mol % to about 20 mol % of an azetidinium group, such as about 1 mol % to about 18 mol %, about 1 mol % to about 16 mol %, about 1 mol % to about 14 mol %, about 1 mol % to about 12 mol %, about 1 mol % to about 10 mol %, about 1 mol % to about 8 mol %, about 1 mol % to about 6 mol %, about 1 mol % to about 4 mol %, about 1 mol % to about 2 mol %, about 3 mol % to about 20 mol %, about 5 mol % to about 20 mol %, about 7 mol % to about 20 mol %, about 9 mol % to about 20 mol %, about 11 mol % to about 20 mol %, about 13 mol % to about 20 mol %, about 15 mol % to about 20 mol %, or about 17 mol % to about 20 mol % of the azetidinium group.

The amount of PAE resin in the composition is not particularly limited. In some embodiments, the amount of PAE resin in the composition may range from about 0.1 wt. % to about 99 wt. %, such as about 0.1 wt. % to about 75 wt. %, about 0.1 wt. % to about 50 wt. %, about 0.1 wt. % to about 35 wt. %, about 0.1 wt. % to about 25 wt. %, about 0.1 wt. % to about 20 wt. %, about 0.1 wt. % to about 15 wt. %, about 0.1 wt. % to about 10 wt. %, about 0.1 wt. % to about 5 wt. %, about 0.1 wt. % to about 3 wt. %, about 0.1 wt. % to about 2 wt. %, about 10 wt. % to about 99 wt. %, about 10 wt. % to about 50 wt. %, or about 10 wt. % to about 30 wt. %.

Compositions of the present disclosure may optionally comprise an organic acid. The organic acid is not particularly limited and may be selected from, for example, acetic acid, acetylsalicylic acid, adipic acid, ascorbic acid, benzoic acid, citric acid, 2,4-dihydroxy benzoic acid, fumaric acid, formic acid, glycolic acid, gluconic acid, glutaric acid, 4-hydroxy benzoic acid, lactic acid, malic acid, oxalic acid, phthalic acid, propionic acid, pyruvic acid, succinic acid, tartaric acid, or any combination thereof. In some embodiments, a composition of the present disclosure excludes an acid, such as a weak acid and/or a strong acid (e.g., HCl).

In certain instances, an adhesive composition of the present disclosure comprises (or excludes) a solvent, such as water.

In those instances where the adhesive composition of the present disclosure comprises an aqueous composition, the composition may comprise a pH of about 3 to about 7, such as about 4 to about 7, about 5 to about 7, about 6 to about 7, about 3 to about 6, about 3 to about 5, or about 3 to about 4. For example, the pH may be about 3.5, 3.6, 3.7, 3.8, 3.9, 4.0, 4.1, 4.2, 4.3, 4.4, or 4.5.

A composition of the present disclosure may comprise any amount of the solvent. For example, a composition may comprise from about 1 wt. % to about 99 wt. % of the solvent, such as from about 10 wt. % to about 90 wt. %, about 20 wt. % to about 80 wt. %, about 30 wt. % to about 70 wt. %, about 40 wt. % to about 60 wt. %, about 50 wt. % to about 95 wt. %, about 60 wt. % to about 95 wt. %, about 70 wt. % to about 95 wt. %, about 80 wt. % to about 95 wt. %, about 90 wt. % to about 95 wt. %, or about 80 wt. % to about 90 wt. %.

A composition disclosed herein may include (or exclude) an additional additive, such as a polyvinyl alcohol or modified polyvinyl alcohol, a polyvinyl acetate, a polyacrylamide, a polyamine, a polyamide, a polyvinylpyrrolidones, a hydrolyzed N-vinylformamide polymer, a polyether, starch, guar gum, carboxymethyl cellulose, hydroxyethyl cellulose, hydroxypropyl cellulose, an oil, a surfactant, a release aid, a humectant, or any combination thereof.

In some embodiments, the additive is selected from an oil-based release aid, a plasticizer-based release aid, a silicone oil, a surfactant, a soap, a shampoo, a humectant, a plasticizer, a water-soluble polyol, a glycol, a glycerol, a sobitol, a polyglycerin, a polyethylene glycol, a sugar, an oligosaccharide, a hydrocarbon oil, and any combination thereof.

In some embodiments, the release aid is based on a quaternized imidazoline (e.g., methyl and ethyl sulfate salts of quaternary imidazoline derived from fatty acids), possibly including a mineral oil, or a vegetable oil or a blend thereof. Alternatively, the release aid may be an oil-based dispersion of paraffinic oil, naphthenic oil, a vegetable oil or a blend thereof. The imidazoline-based release aid itself may have an adjustable viscosity, which can be varied by using a mixture of high boiling compounds as a solvent for the quaternized imidazoline.

The compositions of the present disclosure have stable material properties that allow them to function well as adhesives for a long period. For example, the adhesive compositions may have a Brookfield viscosity of about 25 cP to about 200 cP, such as about 25 cP to about 150 cP, about 25 cP to about 100 cP, about 25 cP to about 50 cP, about 50 cP to about 200 cP, about 100 cP to about 200 cP, about 150 cP to about 200 cP, or about 75 cP to about 125 cP. The foregoing Brookfield viscosities can be achieved immediately after the compositions are manufactured and they can remain stable within 30% variation during storage of the composition, such as during storage for about 30 days or more at temperature about 35° C. to about 180 days or more at ambient temperature.

The foregoing viscosities can be achieved with various concentrations of PAE resin in the compositions, such as any amount disclosed herein. For example, a composition may contain from about 5 wt. % to about 30 wt. % of the PAE resin, such as about 10 wt. %, about 15 wt. %, or about 20 wt. %, and still have a viscosity falling within the target ranges.

The adhesive compositions disclosed herein also have advantageous film solubilities. For example, a composition may have a film solubility of about 10% to about 60%, such as about 20% to about 60%, about 30% to about 60%, about 40% to about 60%, about 50% to about 60%, about 10% to about 50%, about 10% to about 40%, about 10% to about 30%, or about 10% to about 20%. These film solubilities can be achieved immediately after the compositions are manufactured and applied, and they can still be achieved after storage of the composition for a period of time before application, such as about 30 days or more at a temperature higher than 35° C. to about 180 days or more at ambient temperature.

The foregoing film solubilities can be achieved with various concentrations of PAE resin in the compositions, such as any amount disclosed herein. For example, a composition may contain from about 5 wt. % to about 30 wt. % of the PAE resin, such as about 10 wt. %, about 15 wt. %, or about 20 wt. %, and still have a film solubility falling within the ranges set forth above.

The adhesive compositions disclosed herein also have an advantageous film softness. For example, a composition may have a film softness of about 0.8 to about 5 MPa, such as about 1 to about 5 MPa, about 2 to about 5 MPa, about 3 to about 5 MPa, about 4 to about 5 MPa, about 0.8 to about 4 MPa, about 0.8 to about 3 MPa, or about 0.8 to about 2 MPa, when the film contains about 2.5% moisture. The film softness can be achieved immediately after the compositions are manufactured and applied, and it can still be achieved after storage of the composition for a period before application, such as about 30 days or more at a temperature higher than 35° C. to about 180 days or more at ambient temperature.

The foregoing film softness can be achieved with various concentrations of PAE resin in the compositions. For example, a composition may contain from about 5 wt. % to about 30 wt. % of the PAE resin, such as about 10 wt. %, about 15 wt. %, or about 20 wt. %, and still have a film softness falling within the target ranges set forth above.

The adhesive compositions disclosed herein may be used in various methods for improving a papermaking process. In a typical process, a dilute pulp slurry is precisely distributed onto a high-speed forming fabric from a headbox. Water removal begins immediately through a combination of gravity, vacuum, centrifugal force, or any combination thereof. The wet web is then pressed onto the Yankee dryer to a consistency of approximately 40-45%. The sheet is then dried to a consistency of approximately 95% by evaporative and convective drying. The sheet is finally removed from the dryer by a doctor blade, ready for further processing.

It should be noted that the compositions and methods disclosed herein can be used on a conventional tissue papermaking machine, but they can be used with other machines as well, such as a creping through-air drying (CTAD) machine and hybrid machines including NTT, ATMOS, eTAD, QRT, etc.

A method of improving a papermaking process according to the present disclosure may include adding any adhesive composition disclosed herein to a heated surface to form a treated surface. A roller (e.g., Yankee dryer) may comprise the surface/treated surface. The treated surface is heated and contacted with a paper sheet, which adheres to the treated surface. Next, the dried paper sheet is removed from the treated surface. The surface is in general heated when applying the composition.

The compositions disclosed herein may be applied to a surface, such as a surface of a roller (e.g., Yankee dryer) by various means known in the art. For example, the application may involve dripping, pouring, spraying, dipping, showering, or otherwise applying/adding the composition to the surface. In certain embodiments, the composition may be applied when the surface is heated, such as from about 30° C. to 125° C. The composition may be applied automatically or manually. The composition may also be applied intermittently whereby after an amount of the composition is applied and at least a portion (or all) of the surface contacting the sheet is coated with the composition, the application is halted, the paper/tissue manufacturing process is carried out for some period of time, and then additional composition may be applied to the surface to achieve the desired film thickness and/or film coverage on the surface. This process can be repeated multiple times.

The effective amount of the composition to be applied to the surface may differ depending upon the specific situation. For example, the effective amount may range from about 0.1 mg/m² to about 80 mg/m², about 0.1 mg/m² to about 70 mg/m², about 0.1 mg/m² to about 60 mg/m², about 0.1 mg/m² to about 50 mg/m², about 0.1 mg/m² to about 40 mg/m², about 0.1 mg/m² to about 30 mg/m², about 0.1 mg/m² to about 20 mg/m², about 0.1 mg/m² to about 10 mg/m², about 0.5 mg/m² to about 80 mg/m², about 0.5 mg/m² to about 70 mg/m², about 0.5 mg/m² to about 60 mg/m², about 0.5 mg/m² to about 50 mg/m², about 0.5 mg/m² to about 40 mg/m², about 0.5 mg/m² to about 30 mg/m², about 0.5 mg/m² to about 20 mg/m², about 0.5 mg/m² to about 10 mg/m², about 1 mg/m² to 80 mg/m², about 1 mg/m² to about 70 mg/m², about 1 mg/m² to about 60 mg/m², about 1 mg/m² to about 50 mg/m², about 1 mg/m² to about 40 mg/m², about 1 mg/m² to about 30 mg/m², about 1 mg/m² to about 20 mg/m², about 1 mg/m² to about 10 mg/m², about 3 mg/m² to about 10 mg/m², about 3 mg/m² to about 20 mg/m², about 3 mg/m² to about 30 mg/m², about 3 mg/m² to about 40 mg/m², about 3 mg/m² to about 50 mg/m², about 3 mg/m² to about 60 mg/m², about 3 mg/m² to about 70 mg/m², about 3 mg/m² to about 80 mg/m², about 5 mg/m² to about 80 mg/m², about 10 mg/m² to about 80 mg/m², about 20 mg/m² to about 80 mg/m², or about 30 mg/m² to about 80 mg/m².

The present disclosure also provides methods for preparing the adhesive compositions of the present disclosure. In an illustrative, non-limiting embodiment, a method of preparing an adhesive composition comprises synthesizing a PAE resin in any solvent disclosed herein (e.g., water) and then adding an organic base to the PAE solution. The preparation methods disclosed herein may comprise (or exclude) a step of adding an organic acid, such as a weak acid (e.g., acetic acid) to the solvent.

The foregoing may be better understood by reference to the following examples, which are intended for illustrative purposes and are not intended to limit the scope of the disclosure or its application in any way.

### Examples

### PAE Synthesis

The detailed lab synthesis procedures for the polyamidoamine prepolymer and the reactive PAE resins used as adhesives are described in U.S. Pat. No. 9,611,590, the contents of which are incorporated by reference into the present disclosure. A brief outline of the synthetic procedure that was used to prepare the reactive PAE resins of the present examples is as follows. To a 1 L reaction flask equipped with a mechanical stirrer, thermocouple, condenser, and addition ports, about 215.7 grams of polyamidoamine prepolymer was added followed by water to achieve about 15-30 wt. % solid. Then, about 17.4 grams of EPI was added over 30-90 minutes while controlling temperature between about 20-30° C. Reaction temperature was raised to about 40° C. and Brookfield viscosity was monitored every 10-30 minutes until hot viscosity reached 20-50 cps. The mixture was cooled to about 25° C. and Brookfield viscosity was monitored every 10-15 minutes. Upon achieving the desired viscosity of above 200 cps, about 42 grams of phosphoric acid and dilution water were added immediately to reach a final pH in the range of about 3-5. The resulting product is called PAE-1, which has a BFV of about 75 cP, a pH about 3.9, a solid content of about 15%, a weight average molecular weight of about 670,000 Da, an azetidinium content of about 7.1%, and an aminochlorohydrin content of about 10%.

Synthesis of PAE with Extended Shelf Life

About 99.6 grams of PAE-1 were added to a 250 ml beaker with a magnetic stir. Mixing started and the initial pH was recorded. About 0.4 grams of sodium acetate were added to the sample and mixed for about 30 minutes. The final pH was recorded. The resulting product is called PAE-2.

The shelf life of an adhesive composition containing a PAE-1 resin was determined to be approximately three months at ambient temperature. During this period, the adhesive's Brookfield viscosity (BFV) decreases by about 30%, correlating with an approximate 30% reduction in weight-average molecular weight. Concurrently, the azetidinium content increases by 30%, while the aminochlorohydrin content decreases by 50%. Because key PAE adhesive properties, such as film solubility, peel force, and storage modulus, remain within acceptable limits for on-machine performance despite these changes in molecular characteristics, a BFV drop of 30% was established as the threshold for the product's end of shelf life. A BFV decrease exceeding this limit indicates the product is no longer suitable for use.

TABLE 1

| | Film | Peel | Film Storage Modulus |
|---|---|---|---|
| | Solubility | Force | at 3% film retained |
| Sample ID | (%) | (g/in) | moisture (MPa) |
| Fresh PAE-1 | 27.7 ± 0.24 | 880 ± 329 | 2.7 |
| PAE-1 aged 3 months | 31.2 ± 0.1 | 893 ± 353 | 2.7 |
| at 23° C. | | | |

The effectiveness of an organic base on the extension of shelf-life of PAE-1 was tested at 23° C. As shown in Table 2, it takes 3 months for the BFV of PAE-1 to drop by 30%. With the addition of sodium acetate, it takes more than 187 days for the BFV of PAE-2 to drop by 30%.

TABLE 2

| PAE-1 | | | PAE-2 | | |
|---|---|---|---|---|---|
| Storage | | BFV | Storage | | BFV |
| Period | BFV | Drop | Period | BFV | Drop |
| (Day) | (cP) | (%) | (Day) | (cP) | (%) |
| 0 | 74.5 | 0% | 0 | 77 | 0% |
| 36 | 64.6 | 13% | 157 | 72.6 | 6% |
| 65 | 58.6 | 21% | 187 | 63.6 | 17% |
| 93 | 52.2 | 30% | 224 | 52.4 | 32% |
| 120 | 46.4 | 38% | 254 | 50.5 | 34% |

Total solid was determined by the moisture balance, Halogen Moisture Analyzer HE73. Roughly 4 grams of a liquid sample was distributed on about 15 grams of sand in an aluminum pan. The temperature was set to about 105° C. for about 30 to about 45 minutes. The total solid of the sample was calculated by the ratio of mass left after heating over the mass before heating.

Brookfield viscosity was measured using a Brookfield viscometer with a Small Sample Adapter (SSA), Model Programmable LVDV-II+. All measurements were done at 25° C. using SC4 spindle 018 at 30 rpm.

Molecular weight was analyzed by SEC-MALS (Wyatt DAWN-Heleos-II multi-angle light scattering detector, Optilab-rEX differential refractive index detector and TOSOH TSK gel columns) at 1 ml/min, 30° C.

Chemical composition by NMR Proton and carbon spectra were acquired using a Bruker Avance III 500 MHz spectrometer equipped with a 5 mm Prodigy probe and Z-axis gradient. The quantitative proton spectrum was acquired at 50° C. and carbon spectrum was acquired at 25° C. 8 scans and 2048 scans were accumulated to achieve the desired signal-to-noise for proton and carbon spectra, respectively. All data were then processed and analyzed using Mnova (v. 14, Mestrelab, Spain).

180° peel force of a 100% cotton strip off a low carbon steel or cast-iron test plate coated by the PAE adhesive composition was evaluated using an Instron 5500R Peel Test instrument at 100° C. The cotton strip was pulled 42 cm at a rate of 200 mm/min. The average adhesion from 10 to 32 cm was reported by the software as the peel force with unit of grams per inch (g/in).

To prepare the adhesive coating on the test plate, the PAE adhesive composition was spread onto a clean test plate to form a layer of coating with a thickness of about 10 μm using a drawdown rod. The plate was then heated to about 60° C. While the plate was heating, a 2×24-inch cotton strip was soaked in DI water. When the plate reached about 50° C., the strip was passed through a wringer press at about 5 psi to remove extra water and then it was applied onto the steel plate with a rolled cylindrical press. After the strip was applied to the film, the plate was heated to about 100° C. and then placed into a 105° C. oven to dry the strip. Next, the plate was clamped into an Instron unit, and the strip was attached to the load cell with a pneumatic grip. The heating pad was connected to a second temperature controller and re-heated to about 100° C. Once 100° C. was reached, the peel test was started with a peel speed of 200 mm/min at a peel angle of 180°.

Film solubility was measured by ratio of the washed-off mass of the PAE adhesive composition and the total mass of the PAE adhesive composition. To measure the total mass of the PAE adhesive composition, the initial weight of a 1 by 2-inch dry paper towel strip (WtInitial) was recorded and then 1 ml of the PAE adhesive composition was applied evenly onto it. The strip was then dried at 105° C. for 1 hour and then the total weight of the dry coated strip (WtOven—dry) was recorded. The total mass of the PAE adhesive composition was calculated by the mass difference between weight of dry coated strip (WtOven—dry) and dry strip (WtInitial).

To measure the washed-off mass of the adhesive, the dry coated strip was placed in an 8-ounce jar filled with tap water that was preheated to 50° C. in the incubator. The jar was left in the incubator for 1 hour with shaking. The strip was then removed from the jar and dried at 105° C. for about 4 hours. The strip was then weighed (WtFinal). The washed-off mass was calculated by the mass difference between total mass of the PAE adhesive composition (WtOven—dry−WtInitial) and the mass remaining on the strip (WtFinal−WtInitial). Film Solubility was calculated by equation (1):

$$\% Solubility = ( WtOven - dry - WtFinal ) / ( WtOven - dry - WtInitial ) ) \times 100 \qquad ( 1 )$$

Shear modulus measurements were carried out using an Anton-Parr modular compact rheometer (MCR302) under the parallel plate geometry at 100° C. Typical shear modulus measurements were taken by a frequency sweep from 100 to 1 rad/s with shear strain of 0.03%. To avoid moisture loss during measurement, a Peltier-Temperature-Controlled hood was employed, and the sample hold time was limited to 10 s at 100° C. before the frequency sweep was started. During the frequency sweep, shear storage modulus, shear loss modulus, and phase angles were monitored but only shear storage modulus at frequency of 70.2 rad/s, which is about 11 Hz, was used for comparing film softness.

All the compositions and methods disclosed and claimed herein can be made and executed without undue experimentation in light of the present disclosure. While this invention may be embodied in many different forms, there are described in detail herein specific preferred embodiments of the invention. The present disclosure is an exemplification of the principles of the invention and is not intended to limit the invention to the particular embodiments illustrated. In addition, unless expressly stated to the contrary, use of the term “a” is intended to include “at least one” or “one or more.” For example, “a base” is intended to include “at least one base” or “one or more bases.”

Any ranges given either in absolute terms or in approximate terms are intended to encompass both, and any definitions used herein are intended to be clarifying and not limiting. Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all subranges (including all fractional and whole values) subsumed therein.

Any composition disclosed herein may comprise, consist of, or consist essentially of any compound, element, component and/or ingredient disclosed herein or any combination of two or more of the compounds, elements, components or ingredients disclosed herein.

Any method disclosed herein may comprise, consist of, or consist essentially of any method step disclosed herein or any combination of two or more of the method steps disclosed herein.

The transitional phrase “comprising,” which is synonymous with “including,” “containing,” or “characterized by,” is inclusive or open-ended and does not exclude additional, un-recited compounds, elements, components, ingredients and/or method steps.

The transitional phrase “consisting of” excludes any compound element, component, ingredient, and/or method step not specified in the claim.

The transitional phrase “consisting essentially of” limits the scope of a claim to the specified compounds, elements, components, ingredients and/or steps, as well as those that do not materially affect the basic and novel characteristic(s) of the claimed invention.

As used herein, the term “about” refers to the cited value being within the errors arising from the standard deviation found in their respective testing measurements, and if those errors cannot be determined, then “about” may refer to, for example, within 5%, 4%, 3%, 2%, or 1% of the cited value.

Furthermore, the invention encompasses any and all possible combinations of some or all of the various embodiments described herein. It should also be understood that various changes and modifications to the presently preferred embodiments described herein will be apparent to those skilled in the art. Such changes and modifications can be made without departing from the spirit and scope of the invention and without diminishing its intended advantages. It is therefore intended that such changes and modifications be covered by the appended claims.

What is claimed is:

1. An adhesive composition, comprising:
a polyamidoamine-epihalohydrin (PAE) resin, and
an organic base.

2. The adhesive composition of claim 1, wherein the organic base is selected from the group consisting of an acetate, an acetylsalicylate, an adipate, an ascorbate, a benzoate, a citrate, a 2,4-dihydroxy benzoate, a fumarate, a formate, a glycolate, a gluconate, a glutarate, a 4-hydroxybenzoate, a lactate, a malate, an oxalate, a phthalate, a propionate, a pyruvate, a succinate, a tartrate, and any combination thereof.

3. The adhesive composition of claim 1, further comprising from about 10 wt. % to about 99 wt. % of the PAE resin and from about 0.1 wt. % to about 10 wt. % of the organic base.

4. The adhesive composition of claim 1, further comprising an organic acid.

5. The adhesive composition of claim 1, wherein the adhesive composition is an aqueous composition comprising a pH of about 3 to about 7.

6. The adhesive composition of claim 1, wherein the PAE resin comprises from about 1 mol % to about 20 mol % of an azetidinium group and/or from about 1 mol % to about 20 mol % of an aminohalohydrin group.

7. The adhesive composition of claim 1, wherein the adhesive composition comprises a Brookfield viscosity of about 25 cP to about 200 cP.

8. The adhesive composition of claim 1, wherein the adhesive composition comprises a film solubility of about 10% to about 60% and/or a film softness of about 0.8 to about 5 MPa when the film contains about 2.5% moisture.

9. The adhesive composition of claim 1, wherein the PAE resin comprises a polyamidoamine-epichlorohydrin and/or a polyamidoamine-epibromohydrin.

10. The adhesive composition of claim 1, wherein the organic base comprises a pKb from about 9 to about 11.

11. The adhesive composition of claim 1, wherein the composition achieves a Brookfield viscosity loss of less than about 30% after about 210 days of storage at about 23° C.

12. A method of improving a papermaking process, comprising:
adding an adhesive composition to a heated surface to form a treated surface,
adhering a paper sheet to the treated surface, and
removing the paper sheet from the treated surface, wherein the adhesive composition comprises a PAE resin and an organic base.

13. The method of claim 12, wherein the organic base is selected from the group consisting of an acetate, an acetylsalicylate, an adipate, an ascorbate, a benzoate, a citrate, a 2,4-dihydroxy benzoate, a fumarate, a formate, a glycolate, a gluconate, a glutarate, a 4-hydroxybenzoate, a lactate, a malate, an oxalate, a phthalate, a propionate, a pyruvate, a succinate, a tartrate, and any combination thereof.

14. The method of claim 12, wherein the adhesive composition comprises from about 10 wt. % to about 99 wt. % of the PAE resin and from about 0.1 wt. % to about 10 wt. % of the organic base.

15. The method of claim 12, wherein the adhesive composition further comprises an organic acid.

16. The method of claim 12, wherein the adhesive composition is an aqueous composition comprising a pH of about 3 to about 7.

17. The method of claim 12, wherein the PAE resin comprises from about 1 mol % to about 20 mol % of an azetidinium group and/or from about 1 mol % to about 20 mol % of an aminohalohydrin group.

18. The method of claim 12, wherein the adhesive composition comprises a Brookfield viscosity of about 25 cP to about 200 cP, a film solubility of about 10% to about 60%, and/or a film softness of about bout 0.8 to about 5 MPa when the film contains about 2.5% moisture.

19. A method of preparing an adhesive composition, comprising:
adding a PAE resin to a solvent, and
adding an organic base to the solvent.

20. The method of claim 19, further comprising adding an organic acid to the solvent or excluding adding an organic acid to the solvent.
